(19) United States
(12) Patent Application Publication
(10) Pub. No.: US 2007/0200963 A1
(43) Pub. Date: Aug. 30, 2007

(54) Display device

(76) Inventor: Dong-Hyok Shin, Suwon-si (KR)

Correspondence Address: Robert E. Bushnell, Suite 300, 1522 K Street, N.W., Washington, DC, 20005-1202, US

(21) Appl. No.: 11/711,113

(22) Filed: Feb. 27, 2007

(30) Foreign Application Priority Data
Feb. 28, 2006 (KR) 10-2006-0019289

(51) Int. Cl. H04N 5/64

(52) U.S. Cl. 348/836

(57) ABSTRACT

A display device that can transmit or receive radio signals is constructed with a display module including a display panel displaying images, and a case enclosing the display module. The case is constructed with an antenna base formed on a portion of the case and made from a dielectric material, and an antenna formed in the antenna base.

### CLAIM OF PRIORITY

This application makes reference to, incorporates the same herein, and claims all benefits accruing under 35 U.S.C.§119 from an application for DISPLAY DEVICE earlier filed in the Korean Intellectual Property Office on 28 Feb. 2006 and there duly assigned Serial No. 10-2006-0019289.

### BACKGROUND OF THE INVENTION

1. Field of the Invention

The present invention relates to a display device, and more particularly, to a display device including a wireless antenna transmitting or receiving wireless electrical or electronic signals.

2. Description of the Related Art

Plasma display panels (PDPs) are apparatuses displaying images. In PDPs, a discharge gas is filled between two substrates on which a plurality of electrodes are formed, a discharge voltage is applied to the discharge gas to generate ultraviolet rays, and then, the ultraviolet rays excite phosphor layers formed in a pattern to emit visible rays and display a desired image. When PDPs are coupled to a driving device, plasma display modules are formed, and when the plasma display modules are placed in a case, plasma display devices are fabricated.

Since PDPs can be fabricated to be flat, lightweight, and thin as compared to cathode ray tubes (CRTs) that are contemporarily used as display devices, PDPs are considered to be substitutes for CRTs.

The PDP adopts a light emitting mechanism, in which a high voltage is applied to the discharge cell using a direct current (DC) voltage or an alternating current (AC) voltage applied between the electrodes to generate a discharge and to emit light and thereby display one or more viewers, a variety of variable visual images. Due to the above light emitting mechanism, undesirable electro-magnetic interference (EMI) occurs vastly in the PDP.

Therefore, a front surface and a rear surface of the contemporary PDPs are made from a material shielding electromagnetic waves. Thus, the contemporary plasma display device is not suitable for performing wireless communication.

### SUMMARY OF THE INVENTION

It is therefore an object of the present invention to provide an improved display device.

It is another object to provide a plasma display device that may either transmit or receive radio signals by forming a part of a case enclosing a display module constituting the display device by using a material having a high dielectric constant and forming a wireless antenna on the part of the material having the high dielectric constant.

According to an aspect of the present invention, a display device is provides with a display module including a display panel displaying images, and a case enclosing the display module. The case is constructed with an antenna base formed on a portion of the case and made from a dielectric material, and an antenna formed in or on the antenna base.

The antenna base may be made from a dielectric material.

The antenna base may be made from at least one selected from the group consisting of SiO₂, Al₂O₃, TiO₂, BaO, CaO, B₂O₃, ZnO, R₂O, PbO, and Bi₂O₃.

The case may be made from an electromagnetic wave shielding material.

The case may be further constructed with a front cabinet disposed on a front side of the display panel so that a display unit of the display panel can be located at a center of the front cabinet, and a rear cabinet disposed on a rear side of the display panel and coupled to the front cabinet.

The front cabinet may include a window showing the images displayed by the display panel, and a peripheral portion surrounding the window to form a boundary of the front cabinet.

The antenna base may be formed on a portion of the peripheral portion of the front cabinet.

The antenna base may be formed on the entire peripheral portion of the front cabinet so as to surround the window.

According to another aspect of the present invention, a display device is provided with a display module including a display panel displaying images, and a case enclosing the display module. The case is constructed with a front cabinet disposed on a front side of the display panel so that a display unit of the display panel can be located at a center of the front cabinet, a rear cabinet disposed on a rear side of the display panel and coupled to the front cabinet, an antenna base formed on a portion of the front cabinet and made from a dielectric material, and an antenna formed in the antenna base.

The front cabinet may include a window showing the images display by the display panel, a peripheral portion surrounding the window to form a boundary of the front cabinet, and a side portion extending from the peripheral portion at an angle and which is formed on the side surface of the front cabinet that is connected to the rear cabinet.

The antenna base may be formed on a portion of the side portion of the front cabinet.

The antenna base may be formed on the entire side portion of the front cabinet so as to surround the front cabinet.

According to still another aspect of the present invention, there is provided a display device constructed with a display module including a display panel displaying images, and a case enclosing the display module. The case is constructed with a front cabinet disposed on a front side of the display panel so that a display unit of the display panel can be located on a center of the front cabinet, a rear cabinet disposed on a rear side of the display panel and coupled to the front cabinet, an antenna base formed on a portion of the rear cabinet and made from a dielectric material, and an antenna formed in the antenna base.

The front cabinet may include a window showing the images displayed by the display panel, a peripheral portion surrounding the window to form a boundary of the front cabinet, and a side portion extending from the peripheral portion at an angle and formed on the side surface of the front cabinet that is connected to the rear cabinet.

The antenna base may be formed on a portion of a side portion of the rear cabinet that is connected to the front cabinet.

The antenna base may be formed on the entire side portion of the rear cabinet so as to surround the rear cabinet.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view illustrating a plasma display device including a plasma display module constructed as an embodiment according to the principles of the present invention;

FIG. 2 is an exploded perspective view illustrating the plasma display module illustrated in FIG. 1;

FIG. 3 is a schematic view illustrating a plasma display device having a structure illustrated in FIG. 1, in which an antenna is formed on a front surface of a front cabinet of the plasma display device, as an embodiment according to the principles of the present invention;

FIG. 4 is a schematic view illustrating a plasma display device having a structure illustrated in FIG. 1, in which an antenna is formed on a side surface of a front cabinet of the plasma display device, as another embodiment according to the principles of the present invention; and

FIG. 5 is a schematic view illustrating a plasma display device having a structure illustrated in FIG. 1, in which an antenna is formed on a side surface of a rear cabinet of the plasma display device, as still another embodiment according to the principles of the present invention.

### DETAILED DESCRIPTION OF THE INVENTION

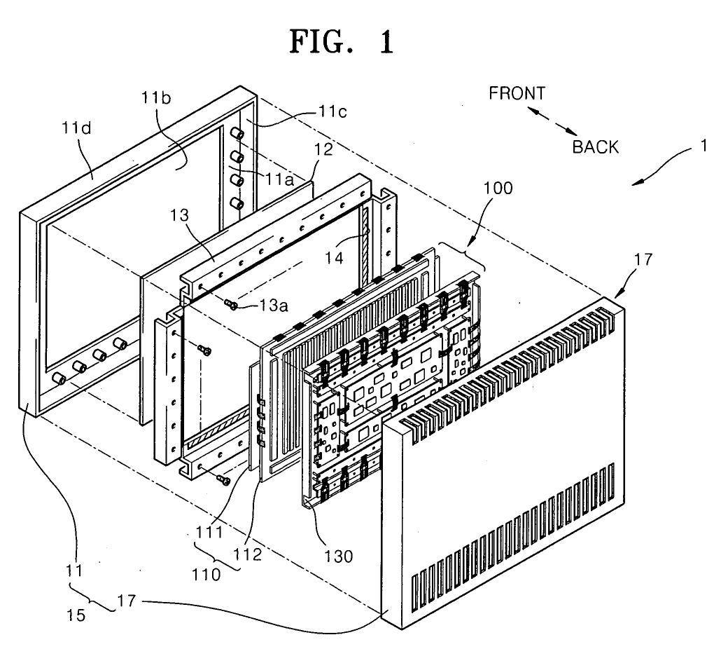

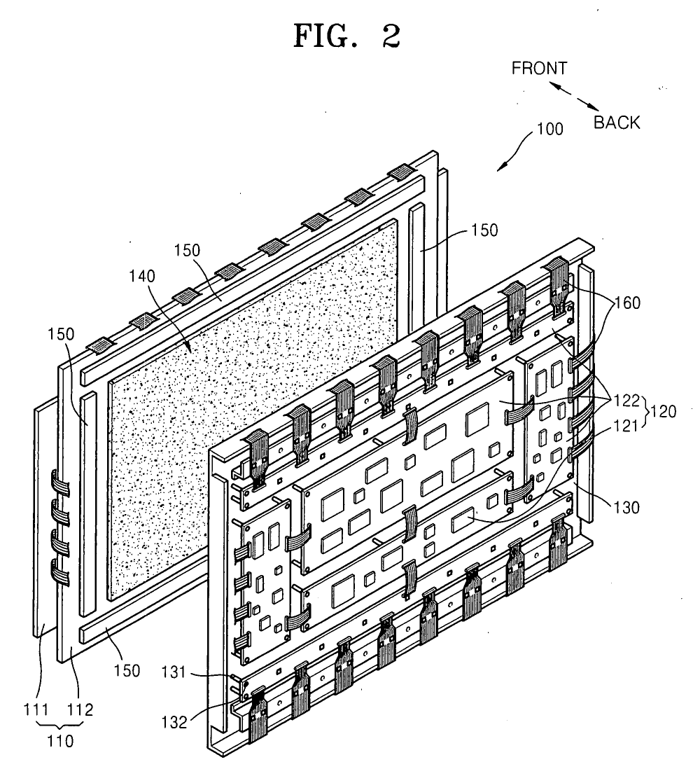

FIG. 1 is in exploded perspective view illustrating a plasma display device 1 including a plasma display module 100 constructed as an embodiment according to the principles of the present invention. FIG. 2 is an exploded perspective view illustrating plasma display module 100 illustrated in FIG. 1 constructed as the embodiment according to the principles of the present invention.

Referring to FIG. 1 and FIG. 2, plasma display device 1 is constructed with plasma display module 100.

Plasma display device 1 is further constructed with a front cabinet 11, an electromagnetic wave shielding filter 12, a filter holder 13, a display panel 110, a chassis 130, a driving unit 120, and a rear cabinet 17.

Front cabinet 11 includes a peripheral portion 11a, a window 11b, and side portions 11c and 11d. Window 11b is formed on the center portion of front cabinet 11, and a user can watch the image displayed by plasma display panel 110 through window 11b.

Peripheral portion 11a is a boundary of front cabinet 11 surrounding window 11b. Side portions 11c and 11d are connected to peripheral portion 11a at an angle, for example, at an angle of 90°. In addition, side portions 11c and 11d are formed on the side portion of front cabinet 11 and are connected to rear cabinet 17.

Electromagnetic wave shielding filter 12 is disposed on a rear side of front cabinet 11 to cover window 11b, and to transmit the image displayed by plasma display panel 110. Filter holder 13 fixes electromagnetic wave shielding filter 12 onto peripheral portion 11a of front cabinet 11.

Plasma display panel 110 is disposed on the rear side of filter holder 13, and is constructed with a first substrate 111 and a second substrate 112. Chassis 130 supports plasma display panel 110 from the rear side of plasma display panel 110. Driving unit 120 is installed on the rear side of chassis 130 to drive plasma display panel 110.

Rear cabinet 17 is disposed on the rear side of driving unit 120 and is coupled to front cabinet 11. Thus, front cabinet 11 and rear cabinet 17 integrally form a case 15 of plasma display device 1.

Electromagnetic wave shielding filter 12 is adhered onto the rear surface of front cabinet 11 by filter holder 13 that is fixed by a screw 13a to peripheral portion 11a of front cabinet 11. Plasma display panel 110 is adhered onto a sponge 14 that is attached on a rear surface of filter holder 13. In addition, driving unit 120 driving display panel 110 is connected to plasma display panel 110 through a cable (not shown), for example, flexible printed cable (FPC).

The rear surface of plasma display panel 110 is attached to chassis 130 through a heat dissipation sheet 140 having a high heat dissipating property, and thus, the heat generated on plasma display panel 110 can be dissipated to the outside sufficiently.

Plasma display module 100, according to the present invention, includes plasma display panel 110, driving unit 120, chassis 130, and heat dissipation sheet 140.

Plasma display panel 100, on which the image is displayed, includes first substrate 111 and second substrate 112. First and second substrates 111 and 112 face each other with an interval therebetween, and a discharge electrode (not shown), a phosphor layer (not shown), and a discharge gas (not shown) are disposed between first and second substrates 111 and 112.

Driving unit 120 includes circuit devices 121 and a circuit board 122 on which circuit devices 121 are disposed. In the present embodiment, circuit board 122 is mounted onto chassis 130 using bosses 131 and bolts 132.

Chassis 130 is made from an electrically conductive material such as steel or aluminum. Chassis 130 of the present embodiment is made from steel or aluminum, but the present invention is not limited thereto. Chassis 130, alternatively, may be made from aluminum or a synthetic resin having a light-weight and high rigidity in consideration of the entire weight of plasma display module 100.

Plasma display panel 110 is attached onto a surface of chassis 130 which is supported by driving unit 120, and driving unit 120 is attached on the other surface of chassis 130 to support chassis 130. In addition, a noise reducing unit (not shown) is formed on a surface of chassis 130 to reduce the noise generated by plasma display panel 110 and driving unit 120.

Plasma display panel 110 and chassis 130 are coupled to each other using a dual-adhesive unit 150 that is attached to second substrate 112 of plasma display panel 110. Dual-adhesive unit 150 is generally a dual-adhesive tape.

Plasma display panel 110 and circuit board 122 are electrically connected to each other using a signal transmission unit 160. Signal transmission unit 160 may be a flexible printed cable (FPC) or a tape carrier package (TCP).

Heat dissipation sheet 140 is disposed between plasma display panel 110 and chassis 130. Heat dissipation sheet 140 is made from graphite having a high thermal conductivity, and a front surface of heat dissipation sheet 140 is attached onto plasma display panel 110.

Heat dissipation sheet 140 of the present embodiment is made from graphite, but the present invention is not limited thereto. That is, heat dissipation sheet 140 of the present invention can be made from any material having a high thermal conductivity.

Plasma display device 1 of the present invention is useful as a plasma display device 1 generating a substantial volume of electro-magnetic interference (EMI) over a wide spectrum, but the present invention is not limited to plasma display device 1 since the present invention can be applied to various kinds of display devices including plasma display device 1.

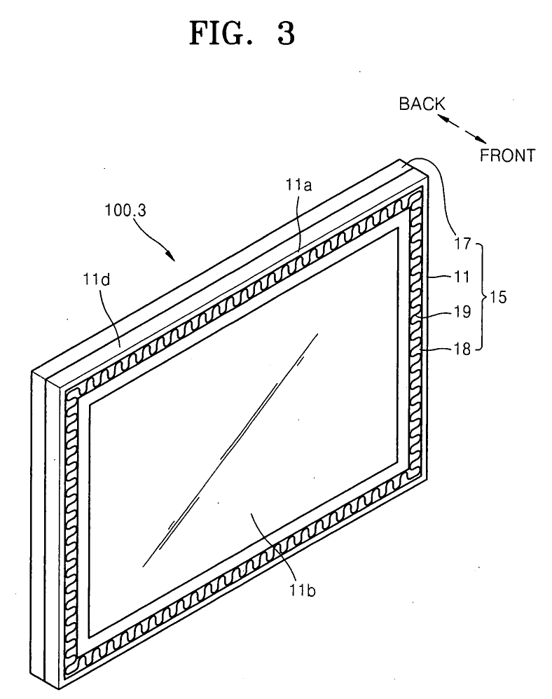

FIG. 3 is a schematic view illustrating a plasma display device 100.3 having a structure as illustrated in FIG. 1, in which an antenna 19 is formed on a front surface of front cabinet 11 of plasma display device 100.3 according to an embodiment of the principles of the present invention.

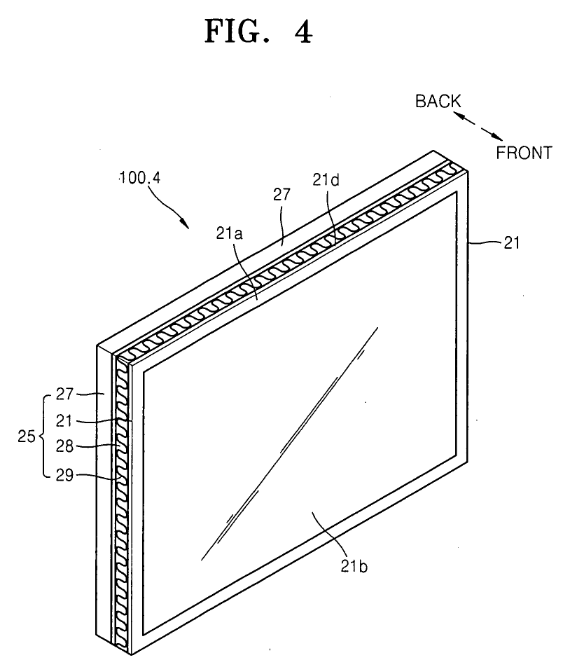

Referring to FIG. 3, plasma display device 100.3 is constructed with a plasma display module 100 (shown in FIGS. 1 and 2, but not shown in FIG. 3) including plasma display panel 110 (shown in FIGS. 1 and 2, but not shown in FIG. 4) that displays images, and a case 15, in which panel display module 100 fits.

Case 15 is constructed with front cabinet 11, that is disposed in front of plasma display panel 110 which constitutes plasma display model 100, rear cabinet 17 disposed on the rear side of plasma display panel 110 and coupled to front cabinet 1, an antenna base 18 formed on a portion of case 15 being made from a dielectric material, and an antenna 19 formed in antenna base 18.

Front cabinet 11, includes window 11b displaying the image displayed by plasma display panel 110, continuous and closed peripheral portion 11a surrounding window 11b and forming a boundary of front cabinet 11, and side portion 11d attached to peripheral portion 11a at an angle, for example, at a 90° angle, and which connects to rear cabinet 17.

In FIG. 3, antenna base 18 is formed on a portion of peripheral portion 11a of front cabinet 11, and antenna 19 is formed in antenna base 18, and is preferable flush with the exposed exterior surface of peripheral portion 11a. Alternatively, antenna base 18 can be formed on the entire peripheral portion 11 of front cabinet so as to surround window 11b.

Front cabinet 11 and rear cabinet 17 are made from a material that serves as a Faraday shield to block propagation of the electromagnetic waves generated during normal operational functions by the plasma display device when projecting visual, variable video images to an audience, so that the EMI generated from plasma display module 100 can be effectively shielded. Therefore, when antenna 19 that can transmit or receive wireless signals is formed in case 15 which includes front and rear cabinet 11 and 17, the electromagnetic wave shielding material prevents the electromagnetic waves generated from plasma display module 100 from interfering with the transmitted wireless electrical signals.

Therefore, antenna base 18 according to the present invention is made from a dielectric material, and antenna 19 is formed in antenna base 18. That is, since antenna 19 is formed in antenna base 18 that is made from the dielectric material, the interference between the electromagnetic waves generated from plasma display module 100 and the transmitted wireless signal can be minimized since case 15 is made from the electromagnetic wave shielding material.

Thus, antenna base 18 may be made from at least one selected from the group consisting of SiO₂, Al₂O₃, TiO₂, BaO, CaO, B₂O₃, ZnO, R₂O, PbO, and Bi₂O₃.

FIG. 4 is a schematic view illustrating a plasma display device 100.4 having a structure as illustrated in FIG. 1, in which an antenna 29 is formed on a side surface of front cabinet 21 of plasma display device 100.4 according to another embodiment of the principles of the present invention.

Referring to FIG. 4, plasma display device 100.4 includes plasma display module 100 (shown in FIGS. 1 and 2, but not shown in FIG. 4) including plasma display panel 110 (shown in FIGS. 1 and 2, but not shown in FIG. 4) that displays images, and a case 25, in which plasma display module 100 fits.

Case 25 is constructed with front cabinet 21 disposed in front of display panel 100 so that a display region of display panel 100 can be located at the center of front cabinet, a rear cabinet 27 disposed on a rear side of plasma display panel 110 and coupled to front cabinet 21, an antenna base 28 formed on a portion of case and made from a dielectric material, and an antenna 29 formed in antenna base 29.

Front cabinet 21 includes a window 21b showing the images displayed by display panel 110, a peripheral portion 21a surrounding the window and forming a boundary of front cabinet 21, and a side portion 21d extending from peripheral portion 21a at an angle, for example, at a 90° angle, and connecting to rear cabinet 27.

Referring to FIG. 4, antenna base 28 is formed on a portion of side portion 21d of front cabinet 21 unlike the embodiment illustrated in FIG. 3. The same elements illustrated in FIG. 4 perform the same functions as the elements denoted with different reference numerals as illustrated in FIG. 3.

In addition, antenna base 28 can be formed on the entire side portion 21d to surround the side surface of front cabinet 21.

Front cabinet 21 and rear cabinet 27 are made from a material that can shield electromagnetic waves so that the EMI generated from plasma display module 100 can be shielded. Therefore, when antenna 29 that can transmit or receive wireless signals is formed in the case, the electromagnetic wave shielding material prevents the electromagnetic waves generated from plasma display module 100 from interfering with the transmission of the wireless signals.

Therefore, antenna base 28 according to the present invention is made from a dielectric material, and antenna 29 is formed in or on antenna base 28. That is, since antenna 29 is formed in antenna base 28 that is made from the dielectric material, the interference between the electromagnetic waves generated from plasma display module 100 and the transmitted wireless signal can be minimized due to antenna base 28 that is made from the electromagnetic wave shielding material.

Thus, antenna base 28 may be made from at least one selected from the group consisting of SiO₂, Al₂O₃, TiO₂, BaO, CaO, B₂O₃, ZnO, R₂O, PbO, and Bi₂O₃.

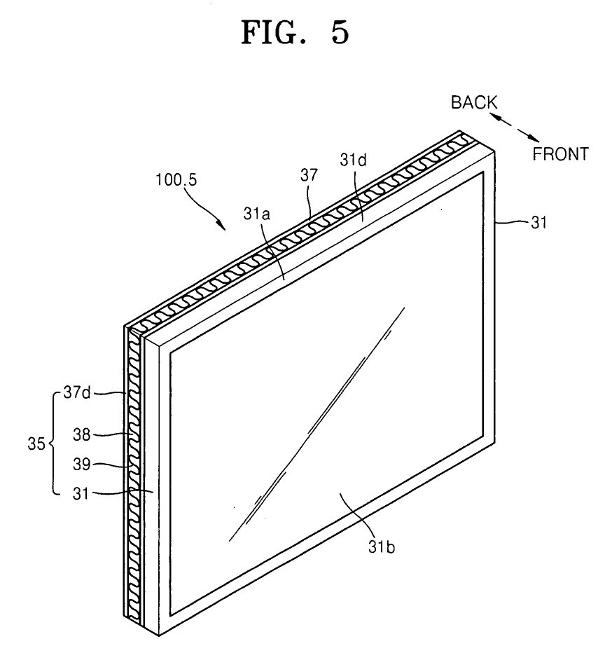

FIG. 5 is a schematic view illustrating a plasma display device 100.5 having a structure as illustrated in FIG. 1, and in which an antenna 39 is formed on a side surface of rear cabinet 37 of plasma display device 100.5 according to still another embodiment of the principles of the present invention.

Referring to FIG. 5, plasma display device 100.5 is constructed with plasma display module 100 (shown in FIGS. 1 and 2, but not shown in FIG. 5) including plasma display panel 110 (shown in FIGS. 1 and 2, but not shown in FIG. 5) displaying the images, and a case 35, in which display module 100 fits.

Case 35 is constructed with a front cabinet 31 disposed in front of plasma display panel 110 so that a display region of plasma display panel 110 can be located at the center of front cabinet 31, a rear cabinet 37 disposed on a rear side of display panel 110 and coupled to front cabinet 31, an antenna base 38 formed on a portion of the case and made from a dielectric material, and an antenna 39 formed in antenna base 38.

Front cabinet 31 includes a window 31b showing the image displayed by plasma display panel 110, a peripheral portion 31a surrounding the window and forming a boundary of front cabinet 31, and a side portion 31d extending from peripheral portion 31a at an angle, for example, at a 90° angle, and connecting to rear cabinet 37.

In addition, rear cabinet 37 includes a side portion 37d extending from the rear surface of rear cabinet 37 at a predetermined angle, for example, at a 90° angle, and connected to front cabinet 31.

In FIG. 5, antenna base 38 is integrated into a portion of side portion 37d of rear cabinet 37. In addition, the same reference numerals as those of FIG. 3 denote the same elements performing the same functions.

In addition, antenna base 38 can be formed on the entire side portion 37d of rear cabinet 37 to surround the side surface of rear cabinet 37.

Front cabinet 31 and rear cabinet 37 are made from a material that can shield the electromagnetic waves so that the EMI generated from plasma display module 100 can be shielded. Therefore, when antenna 39 which transmits or receives wireless signals is formed in the case, the electromagnetic wave shielding material may prevent the electromagnetic waves generated from plasma display module 100 from interfering with the transmission of the wireless signals.

Therefore, antenna base 38 according to the present invention includes a dielectric material, and antenna 39 is formed in antenna base 38. That is, since antenna 39 is formed in antenna base 38 that is made from the dielectric material, the interference between the electromagnetic waves generated from plasma display module 100 and the transmitted wireless signal can be minimized due to the case that is made from the electromagnetic wave shielding material.

Thus, antenna base 38 may be made from at least one selected from the group consisting of SiO₂, Al₂O₃, TiO₂, BaO, CaO, B₂O₃, ZnO, R₂O, PbO, and Bi₂O₃.

According to the plasma display device of the present invention, an antenna is borne by the antenna's base, and the antenna is thus incorporated into and thereby integrated with the case that encases the plasma display panel, flush with the exterior surface of the corresponding peripheral side of the case, either along the front or outer side of the front cabinet, or along a corresponding portion of the rear case. Since a part of the case, in which the plasma display module is received, is made from a material having a high dielectric constant, and the wireless antenna is formed in the portion made from the high dielectric material, the wireless signals can be transmitted without interference.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display device, comprising:
a display module including a display panel disposed to display variable video images; and
a case enclosing the display module, with the case comprising:
an antenna base made from a dielectric material formed on a portion of the case; and
an antenna incorporated into the antenna base.

2. The display device of claim 1, with the antenna base comprising a dielectric material.

3. The display device of claim 1, with the antenna base comprising at least one selected from the group consisting essentially of SiO₂, Al₂O₃, TiO₂, BaO, CaO, B₂O₃, ZnO, R₂O, PbO, and Bi₂O₃.

4. The display device of claim 1, with the case comprising an electromagnetic wave shielding material.

5. The display device of claim 1, with the case further comprising:
a front cabinet disposed on a front side of the display panel so that a display unit of the display panel can be located at a center of the front cabinet; and
a rear cabinet disposed on a rear side of the display panel and coupled to the front cabinet.

6. The display device of claim 5, with the front cabinet comprising:
a window showing the images displayed by the display panel; and
a peripheral portion surrounding the window to form a boundary of the front cabinet.

7. The display device of claim 6, with the antenna base being located at a peripheral portion of the front cabinet.

8. The display device of claim 6, with the antenna base being formed along a peripheral portion of the front cabinet so as to surround the window.

9. A display device, comprising:
a display module including a display panel disposed to display visible variable video images; and
a case fitting the display module, with the case comprising:
a front cabinet encasing on a front side of the display panel so that a display unit of the display panel can be located at a center of the front cabinet;
a rear cabinet disposed on a rear side of the display panel and coupled to the front cabinet;
an antenna base made from a dielectric material formed on a portion of the bezel; and
an antenna borne by the antenna base.

10. The display device of claim 9, with the front cabinet comprising:
a window showing the images on the display panel;
a peripheral portion surrounding the window to form a boundary of the front cabinet; and
a side portion extending from the peripheral portion at an angle and forming the side surface of the front cabinet that is connected to the rear cabinet.

11. The display device of claim 10, with the antenna base being formed on the side portion of the front cabinet.

12. The display device of claim 10, with the antenna base being formed on the side portion of the front cabinet so as to surround the front cabinet.

13. The display device of claim 9, with the antenna base comprising at least one selected from the group consisting essentially of SiO₂, Al₂O₃, TiO₂, BaO, CaO, B₂O₃, ZnO, R₂O, PbO, and Bi₂O₃.

14. The display device of claim 9, with the case comprising an electromagnetic wave shielding material.

15. A display device, comprising:
a display module including a display panel displaying variable video images; and
a case encasing the display module, with the case comprising:
a front cabinet disposed on a front side of the display panel so that a display unit of the display panel will be located on a center of the front cabinet;
a rear cabinet disposed on a rear side of the display panel and coupled to the front cabinet;
an antenna base made from a dielectric material formed on a portion of the rear cabinet; and
an antenna formed in or on the antenna base.

16. The display device of claim 15, with the front cabinet comprising:
a window showing the images on the display panel;
a peripheral portion surrounding the window to form a boundary of the front cabinet; and
a side portion extending from the peripheral portion at a predetermined angle and to form the side surface of the front cabinet that is connected to the rear cabinet.

17. The display device of claim 16, with the antenna base being formed on a side portion of the rear cabinet that is connected to the front cabinet.

18. The display device of claim 17, with the antenna base being formed on the side portion of the rear cabinet so as to surround the rear cabinet.

19. The display device of claim 15, with the antenna base comprising at least one selected from the group consisting essentially of SiO₂, Al₂O₃, TiO₂, BaO, CaO, B₂O₃, ZnO, R₂O, PbO, and Bi₂O₃.

20. The display device of claim 15, with the case comprising an electromagnetic wave shielding material.
